(19) United States
(12) Patent Application Publication
(10) Pub. No.: US 2013/0181993 A1
(43) Pub. Date: Jul. 18, 2013

(54) PLACE HEAT GEOMETRIES

(71) Applicants: Fiona Elizabeth HERRING, London (GB); Thomas Matthew James HENNIGAN, Buckinghamshire (GB); Gemma EXTON, London (GB); Marc Peter Tarca WILSON, London (GB); Andrew ELAND, London (GB); Sarah FORTUNE, London (GB)

(72) Inventors: Fiona Elizabeth HERRING, London (GB); Thomas Matthew James HENNIGAN, Buckinghamshire (GB); Gemma EXTON, London (GB); Marc Peter Tarca WILSON, London (GB); Andrew ELAND, London (GB); Sarah FORTUNE, London (GB)

(21) Appl. No.: 13/741,235

(22) Filed: Jan. 14, 2013

Related U.S. Application Data
(60) Provisional application No. 61/586,714, filed on Jan. 13, 2012.

(51) Int. Cl. G06T 11/20

(52) U.S. Cl. CPC G06T 11/206
USPC 345/440

(57) ABSTRACT

A process for determining and labeling areas of interest, including steps for receiving a plurality of data points from a plurality of users, each data point received at a particular time, determining a user location for each of the plurality of data points and generating a heat map from the plurality of data points, wherein the heat map represents a population density distribution over a geographic area divided into a plurality of cells. In certain aspects, the process further includes steps for identifying at least one cluster of cells within the geographic, generating a bounded polygon for the at least one cluster of cells and storing the at least one cluster of cells and its corresponding bounded polygon as an area of interest in a geographical information system. Systems and machine-readable media are also provided.

This application claims the benefit of U.S. Provisional Application No. 61/586,714, filed Jan. 13, 2012, entitled “PLACE HEAT GEOMETRIES,” which is incorporated herein by reference.

### BACKGROUND

The subject disclosure relates generally to the determination of geographic boundaries for interest areas. Specifically the subject disclosure relates to the determination and labeling of unofficial interest areas based on time-dependent heat map data.

Location and label information (e.g., name and place labels) for official geographic regions and points of interest is often easy to find from maps, etc. However, boundary and label information is more difficult to ascertain for unofficial areas, such as neighborhoods and boroughs, where boundaries and colloquial labels tend to shift and change over time.

### SUMMARY

In certain aspects, the subject technology relates to a computer-implemented method for determining and labeling areas of interest, the method including steps for receiving a plurality of data points from a plurality of users, each data point received at a particular time, determining a user location for each of the plurality of data points, generating a heat map from the plurality of data points, wherein the heat map represents a population density distribution over a geographic area divided into a plurality of cells and identifying cells within the geographic area having a population density that exceeds a threshold. In certain aspects, the method can further include steps for identifying at least one cluster of cells within the geographic area from the identified cells, generating a bounded polygon for the at least one cluster of cells and storing the at least one cluster of cells and its corresponding bounded polygon as an area of interest in a geographical information system.

In other aspects, the subject technology relates to a system for determining and labeling areas of interest, the system including one or more processors and a machine-readable medium comprising instructions stored thereon, which when executed by the processors, cause the processors to perform operations that include receiving a plurality of data points from a plurality of users, each data point received at a particular time, determining a user location for each of the plurality of data points, generating a heat map from the plurality of data points, wherein the heat map represents a population density distribution over a geographic area divided into a plurality of cells and determining a threshold from an average population density for the cells in the geographic area. In certain aspects, the processors can further be configured to perform operations for identifying cells within the geographic area having a population density that exceeds the threshold, identifying at least one cluster of cells within the geographic area from the identified cells, generating a bounded polygon for the at least one cluster of cells and storing the at least one cluster of cells and its corresponding bounded polygon as an area of interest in a geographical information system.

In yet another aspect, the subject technology relates to a machine-readable medium comprising instructions stored therein, which when executed by a machine, causes the machine to perform operations including receiving a plurality of data points from a plurality of users, each data point received at a particular time, determining a user location for each of the plurality of data points, generating a heat map from the plurality of data points, wherein the heat map represents a population density distribution over a geographic area divided into a plurality of cells and determining a threshold from an average population density for the cells in the geographic area. In certain implementations, the instructions may further cause the machine to perform operations for identifying cells within the geographic area having a population density that exceeds the threshold, identifying at least one cluster of cells within the geographic area from the identified cells, generating a bounded polygon for the at least one cluster of cells and storing the at least one cluster of cells and its corresponding bounded polygon as an area of interest in a geographical information system.

It is understood that other configurations of the subject technology will become apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative, and not restrictive in nature.

### BRIEF DESCRIPTION OF THE DRAWINGS

Certain features of the subject technology are set forth in the appended claims. However, for the purpose of explanation, several embodiments of the subject technology are set forth in the following figures.

FIGS. 1A and 1B illustrate flow diagrams of example methods for determining and labeling areas of interest, according to certain aspects of the subject disclosure.

FIG. 2 illustrates an example heat map partitioned into a plurality of cells, according to some aspects.

FIGS. 3A and 3B conceptually illustrate an example of steps for processing heat map data within a single cell.

FIG. 4 illustrates an example network that can be used to implementing some aspects of the subject technology.

FIG. 5 conceptually illustrates an electronic system that can be used to implement some aspects of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Specifically, the instant disclosure utilizes heat map data representing a population density distribution to determine potential areas of interest. Although, heat map data can be based on any information indicating the location of an individual (or a group of individuals), in certain aspects, heat map data is based on geo-location data that can be received from a variety of sources. For example, geo-location data may be received via one or more sources including, but not limited to, anonymized global positioning system (GPS) information received via map viewport requests or location requests, user-reported check-ins, user provided reviews, direction queries, IP geo-location predictions and/or geo-tagged content, etc.

In certain aspects, areas of interest are identified based on whether or not the heat density for a potential interest area exceeds a predetermined heat threshold. Although different metrics can be used for making this determination, one method involves measuring the density of geo-location requests across a specific area and then selecting relative peaks (with respect to area averages) that exceed a predetermined heat threshold. By taking into consideration area averages, this approach avoids some of the problems with defining tiered thresholds for different locations based on a global variable such as population density e.g., cities of similar population often exhibit different density distributions in terms of received geo-location requests.

Subsequently, the heat map is partitioned into a plurality of cells so that potential interest areas existing within each cell may be independently processed. In some examples, processing for any particular cell first involves clustering the heat map data of the potential interest areas within the cell to ascertain continuities between features. Clustering can be performed in a number of ways, for example, in some aspects clustering can be performed using known algorithms e.g., DBScan, etc. The process of clustering potential areas on the heat map can involve “sanitizing” the heat map data to fill in gaps and/or remove undesirable features such as holes, overlaps and/or areas of little relevance or interest.

Interest polygons are generated from the sanitized clusters to define bounded geographic interest areas. This process involves generating boundaries around single clusters (or groups of clusters) to be considered together to form one or more interest polygons. Although any process sufficient to produce bounded shapes around cluster data can be used to produce interest polygons, in some implementations, standard programming library functions or routines (such as AlphaShape), may be used.

Because the process of clustering and generating interest polygons for any particular cell can be performed independently from the processing of other cells, multiple cells may be processed in parallel. When processing of adjacent cells is completed, the interest polygons of adjacent cells representing contiguous interest areas can be merged.

Subsequently, interest polygons can then be associated with labels and/or geographic features through comparison with known database information and stored to one or more geographical information systems. The association of name/label information with interest polygons may be performed based on the relevance of colloquial names, points of interest and business locations bounded by the interest polygons. In one example, labels are attached to an interest polygon based on an amount of overlap with known regions. This comparison of region overlap may utilize weighted averages for certain known areas that are deemed to be of greater rank or relevance; thus, a smaller amount of overlap for a region or feature of high importance can be weighted more heavily than a larger area of overlap for a region or feature of little interest.

As with the determination of interest polygon boundaries, labeling associations for each interest polygon can be made independently of associations made for other polygons such that labeling can proceed in parallel with the processing steps performed for other cells, as described above.

In some implementations, interest polygon boundaries may vary over time due to corresponding time-varying changes in heat map data. For example, some geographic regions or neighborhoods may receive a large relative number of visitors during certain times of the day (e.g., morning, afternoon and/or nighttime), week (e.g., weekends or weekdays) and/or season. Thus, the heat map data for certain areas can vary significantly with time, resulting in changes in the corresponding interest polygon boundaries. As such, the associations between interest polygons and the associated name and/or feature tags can also vary with time.

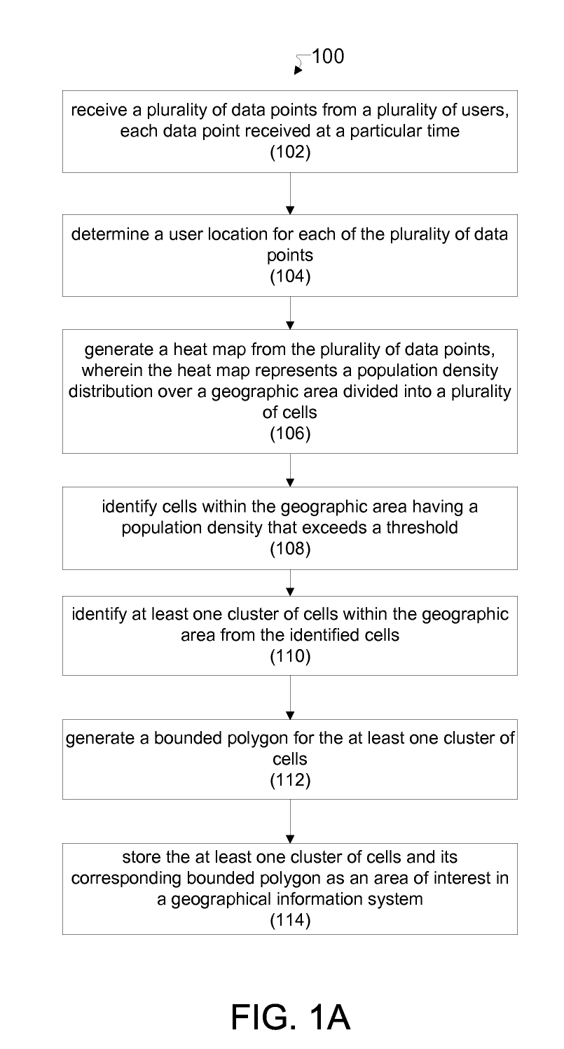

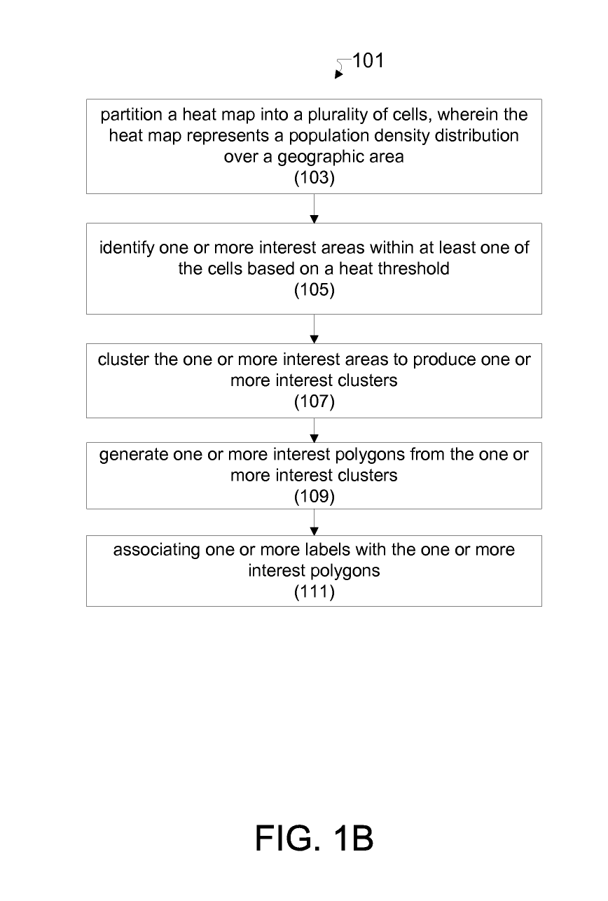

FIG. 1A illustrates a flow diagram of an example process 100 for determining and labeling areas of interest, according to certain aspects of the subject technology. Process 100 begins with step 102 in which a plurality of data points are received from a plurality of users, and wherein each data point is received at a particular time. The plurality of data points can potentially be received from any number of users, each located in a similar or different geographic location. In certain aspects, the plurality of data points will include information relating to the geographic position of the corresponding user; however, depending on implementation, the data points may include other types of information, such as user specific information. By way of example, the data points can include position information of various types, including, but not limited to, GPS data, Wi-Fi access point data, check-in data, and/or IP geo-location data.

In step 104, a user location is determined for each of the plurality of data points received in step 102. The determination of the user location for each of the plurality of data points can be based on location information included in data for the plurality of data points. For example, a GPS coordinate received as a data point for a particular user may be used to determined a corresponding location associated with that particular user.

In step 106, a heat map is generated from the plurality of data points, wherein the heat map represents a population density distribution over a geographic area. The heat map is further sub-divided into a plurality of cells, each covering a portion of area within the geographic region covered by the heat map. Similarly sized geographic areas (or the same geographic area) may be divided into different numbers of cells having different sizes. For example, a geographic area encompassing a city may be divided into a first group of cells, each covering a specified geographic area (e.g., several square miles), or the geographic area may be divided into a second group of cells (including more cells than the first group), each covering a smaller geographic area (e.g., several square city blocks).

In step 108, cells are identified within the geographic area having a population density that exceeds a threshold. In some implementations, identifying cells having a population density exceeding a predetermined threshold will ensure that only relevant geographic areas (e.g., “areas of interest”) are identified for further processing. Additionally, by eliminating cells having a low population density, the anonymity of users associated with data points originating from those cells may be maintained.

Although the threshold used to identify cells with high population densities may be determined in various ways, depending on implementation, the threshold may be predetermined based on an average population density for all cells in a geographic area.

In step 110, at least one cluster of cells within the geographic area from the identified cells is identified. Subsequently, in step 112, a bounded polygon is generated for the identified cluster of cells. By way of example, a bounded polygon for a particular cluster may be generated such that the bounded polygon contains the particular cluster. In certain aspects, the borders of the generated polygon will approximate the borders of the corresponding cluster. As such, the polygon for a cluster may be used to approximate or represent the geographic area of the cluster.

In step 114, at least one cluster of cells and its corresponding bounded polygon are stored as an area of interest in a geographical information system. The storage of a cluster of cells and its corresponding bounded polygon may include the association and of one or more labels with the bounded polygon. The association of clusters of cells with a bounded polygon and/or the association of labels with a polygon can be performed for the purpose of labeling unofficial geographic areas of interest, such as neighborhoods or boroughs, as will be described in further detail below.

FIG. 1B illustrates a flow diagram of an example process 101 for associating one or more labels with one or more interest polygons according to another aspect of the subject technology. Process 101 begins with step 103 in which a heat map is partitioned into a plurality of cells (i.e., view cells), wherein the heat map represents a population density distribution over a geographic area. As discussed above, heat map data can be obtained from any information source indicating population densities (or relative population densities) across a geographic region. For example, heat map data may be derived from data indicating the location of pedestrians, such as geo-location requests determined from a GPS device (e.g., map viewport requests), user-reported check-ins (e.g., to a business, place of interest, city, neighborhood, etc.), user provided reviews, directions queries, IP geo-location predictions and/or geo-tagged content such as photos, micro-blogs, etc. In certain aspects, heat map data may be based on pedestrian geo-location tracks, such as geo-location tracks beginning in, or passing through, a particular region or cell.

The availability of location information pertaining to one or more users/individuals may be limited by user privacy settings. For example, the availability of a particular user's location information may be dependent upon the user's decision to be included in (or to be excluded from) the sharing of location related information. Additionally, heat map data not meeting a particular threshold (e.g., indicating the presence of minimum number of people or pedestrians) may be disregarded for privacy reasons.

In step, 105 one or more interest areas within the cells are identified based on a heat threshold. In some examples, interest areas can be geographic areas or regions that are the “hottest” on the heat map (i.e., that contain the highest per area density of pedestrians), such a popular places in a city. Identification of interest areas within a particular cell can proceed independently of the identification of interest areas for other cells; thus, in some implementations, processing among multiple cells can be performed in parallel.

Identification of one or more interest areas for any given cell can be based on any metric that can be used for successfully identifying potential interest areas. Depending on implementation, the heat map threshold necessary for a specific area on the heat map to be identified as an area of interest may vary greatly. In certain aspects, the threshold may be based, at least in part, on the population density of the surrounding geographic regions. For example, for a particular interest area located within a high population density region to be considered of interest, the population density for that particular interest area may need to be significantly higher than for that of an equal area in a low population density region. Thus, in certain aspects, the identification of one or more interest areas within one or more cells could involve determining an average population density and/or peak population densities for one or more of the plurality of cells.

Due to varying technology characteristics between different pedestrian populations, the determination as to whether a particular area is of interest can be based on the relative density of pedestrian location information from a particular region, relative to the technology characteristics of that region (or other regions). In some implementations, heat map data may be normalized to compensate for differences within a cell and/or as compared to other cells.

Regions on the heat map that do not meet threshold requirements may be disregarded. Thus, in some implementations, the step of identifying one or more interest areas for any given cell can involve a reduction in heat map information to be used in the further processing steps, as described below.

In step 107, clustering is performed on the one or more interest areas within a cell to produce one or more interest clusters. Clustering involves the determination of which interest areas within a given cell, or across multiple cells, can be combined or grouped into contiguous interest clusters.

The process of clustering can further include the sanitization of heat map data of one or more interest clusters. Depending on the interest clusters and implementation, sanitization can include disregarding certain interest clusters and/or the filling in of gaps or “holes” in one or more interest clusters. By way of example, if a particular interest cluster contains a geographic feature or structure (e.g., a lake or pond in a theme park) where no pedestrians are likely to exist, the interest cluster containing this feature may contain an empty spot or “hole” (where the population density is relatively low in comparison to the surrounding area). Sanitization may be used to “fill in” any discontinuities or “holes” in order to form contiguous interest clusters.

Sanitization can also be used to disregard interest clusters and/or parts of interest clusters that are determined to be of low relevance. For example, interest cluster sanitization may involve determining whether two or more interest clusters share a common overlap and in a case that it is determined that two or more interest clusters share a common overlap, combining the two or more interest clusters to remove the common overlap. Additionally, interest cluster sanitization may include processes for identifying one or more duplicate interest clusters and removing unnecessary duplicates.

In step 109, one or more interest polygons are generated from one or more interest clusters in at least one cell. In certain aspects, interest polygons are bounded geometric shapes representing a particular geographic region of interest (e.g., a bounded geometric shape representing one or more interest clusters). Interest polygons can be representative of colloquial geographic areas, such as neighborhoods or boroughs.

As with the interest area identification (i.e., thresholding) and clustering described above with respect to steps 105 and 107 (respectively), the generation of interest polygons within a given cell and between multiple cells can be performed independently. Thus, the processing and generation of interest polygons for a particular cell can occur in parallel with the processing and generation of interest polygons for one or more other cells. Additionally, in some circumstances, the population density for any given region or area will vary as a function of time. As such, the corresponding heat map data will vary accordingly. Thus, in certain aspects the geometry of the interest polygons will change for different times and/or time periods.

In step 111, one or more interest polygons are associated with one or more labels and/or feature names. The geographic regions defined by interest polygons can correspond to, or interact with, known points of interest. For example, identified interest areas may correspond to known landmarks, businesses, neighborhoods or popular areas in which pedestrians congregate, such as tourist attractions and shopping centers, etc. Thus, the association of interest polygons with labels and/or feature names can be performed using a database of known names and/or features that exist within (or overlap with) the geographic regions defined by any given interest polygon.

The association of a particular label and/or name with a particular interest polygon may be based on a known ranking of most relevant colloquial names or labels associated with all or a part of the area encompassed by one or more interest polygons. By way of example, an interest polygon containing the South Bank in London may interact with multiple features and/or regions, e.g., the London Eye, Jubilee Gardens and the Millennium Peer. However, using a name/label association based on relevance rank, the interest polygon for this region would be called “London Eye,” which is the most appropriate colloquial term for the area.

Name and label associations may also be based on how much geographic area overlap is shared between a particular interest polygon and one or more regions and/or features on the map. In some aspects, label and naming associations may be performed based on weighted importance parameters; for example, if an interest polygon overlaps a first map area that is strongly associated with a first name and also overlaps a second map area that is weakly associated with a second name, the first name may be chosen for association with the interest polygon.

Due to fluctuations in the underlying heat map data, boundaries of the interest polygons are subject to change with respect to time. As such, naming and label associations may also vary with respect to time. In certain aspects, one or more interest polygons may be associated with an area containing points of interest that vary throughout the day or week, etc. Thus, the names and/or labels associated with the interest polygons may vary correspondingly. By way of example, a particular colloquial area may be known for tourist attractions during the day or certain seasons and may be better known for particular bars and clubs at night or during different seasons. As such, name and label associations for the interest polygons containing the colloquial area may change from day to day, between weekdays and weekends and/or during different seasons, etc.

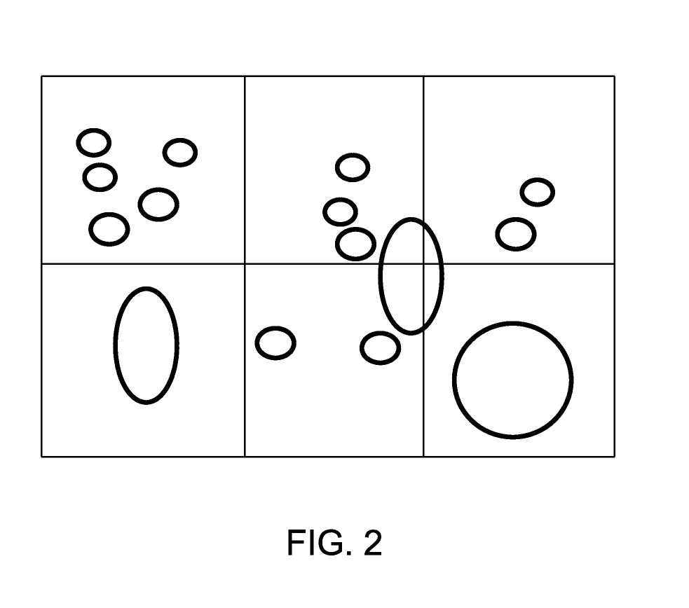

FIG. 2 conceptually illustrates an example of a heat map partitioned into a plurality of six cells (e.g., “view cells”), according to some aspects of the subject technology. Heat map data may be partitioned into any number of cells and depending on implementation, the cells may cover equal or different sized geographic areas.

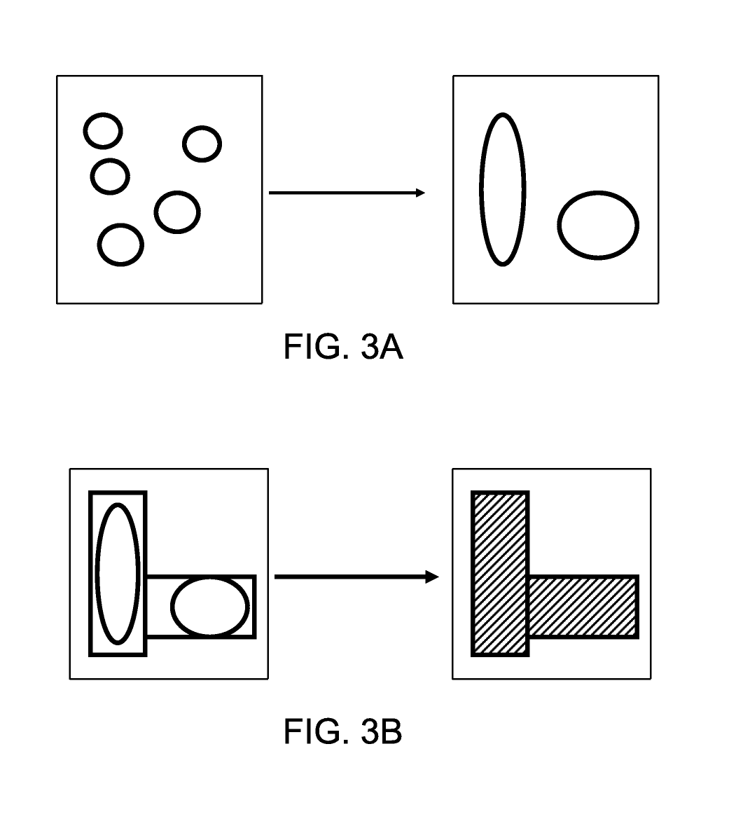

FIGS. 3A and 3B conceptually illustrate examples of steps for processing heat map data within a single cell, for example, a single cell from the six cells illustrated in FIG. 2, above. As illustrated, FIG. 3A shows the process of identifying interest areas (left) to produce interest clusters (right). As discussed above, clustering interest areas into interest clusters can involve determining which interest areas share common points that may form contiguous interest clusters and/or which heat map data should be augmented or disregarded. For example, the process of sanitizing heat map data can also involve the removal of duplicate interest clusters and interest cluster overlap and/or the filling in of gaps and holes.

FIG. 3B conceptually illustrates the process of determining the borders of bounded geometric shapes encompassing one or more interest clusters (left) to produce one or more interest polygons (right). As discussed above, the geometry and associated names/labels of any particular interest polygons may change as a function of time due to changing pedestrian heat map data and/or due to changing trends in the colloquial names/labels used to describe certain areas or points of interest.

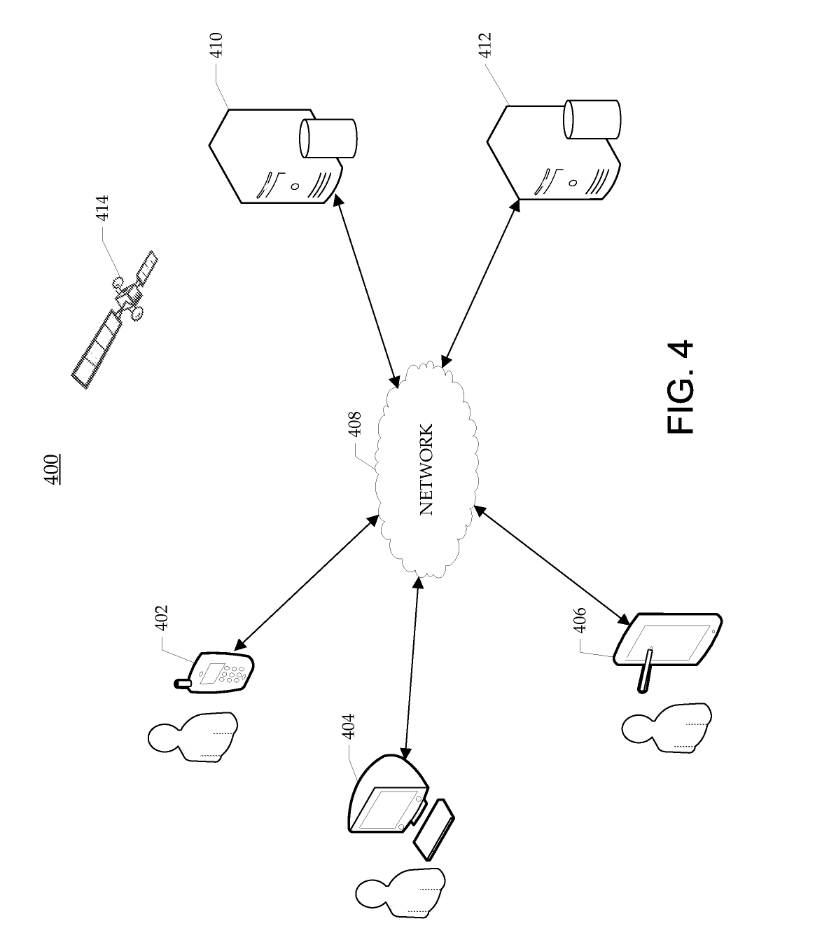

FIG. 4 illustrates an example network that can be used to implementing some aspects of the subject technology. Specifically, the network system 400 comprises user devices 402, 404 and 406, a network 408, a first server 410, a second server 412 and a GPS satellite 414. As illustrated, user devices 402, 404 and 406 are communicatively connected to the first server 410 and the second server 412 via the network 408. In addition to the user devices 402, 404, 406, the first server 410 and the second server 412, any number of other processor-based devices could be communicatively connected to the network 408, and used to implement one or more of the process steps of the subject technology. Additionally, any of the user devices 402, 404 and 406 may be configured to receive a GPS signal from one or more GPS satellites, e.g., the GPS satellite 414.

One or more of the process steps of the subject technology may be carried out by one or more of the user devices 402, 404, 406 and/or the first server 410 and the second server 412. In certain aspects, heat map data may be generated based at least in part on location signals received from one or more of the user devices 402, 404 and 406. For example, one or more computing devices, for example the first server 410, may receive heat map data based on location signals originating from pedestrians using the user devices 402, 404 and/or 406, etc.

Additionally one or more computing devices, such as the first server 410, may be used to partition the heat map into a plurality of cells for further processing, wherein the heat map represents a population density distribution over a geographic area. One or more of the first server 410 and/or the second server 412 may be used to process the heat map data of one or more cells in order to generate one or more interest polygons. For example, the first server 410 and/or the second server 412 may be configured to identify one or more interest areas within at least one of the cells based on a heat threshold and cluster the one or more interest areas within the cells to produce one or more interest clusters in the cells. In certain aspects, the servers 410 and/or 412 can be further configured to generate one or more interest polygons from the one or more interest clusters in the at least one of the cells and associate one or more labels with the one or more interest polygons.

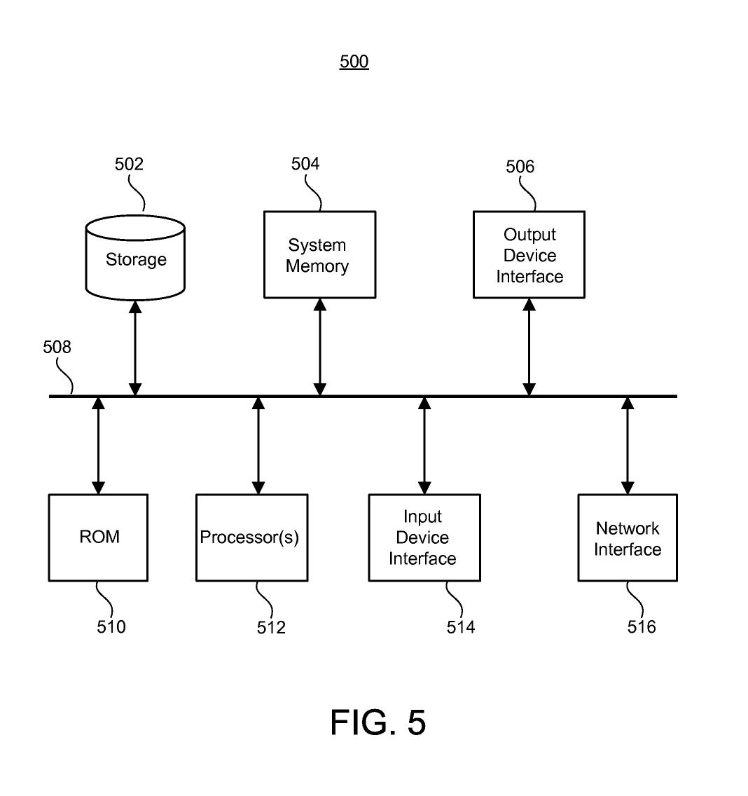

FIG. 5 illustrates an example of an electronic system that can be used for executing the steps of the subject disclosure. The electronic system 500 may be a single computing device such as a server (e.g., the first server 410 and/or the second server 412), discussed above. The electronic system may comprise one or more user device connected to the network 408 (e.g. the user devices 402, 404 and/or 406), discussed above. In some implementations, the electronic system 500 can be operated alone or together with one or more other electronic systems e.g., as part of a cluster or a network of computers.

As illustrated, the processor-based system 500 comprises storage 502, a system memory 504, an output device interface 506, system bus 508, ROM 510, one or more processor(s) 512, input device interface 514 and a network interface 516. In some aspects, the system bus 508 collectively represents all system, peripheral, and chipset buses that communicatively connect the numerous internal devices of the processor-based system 500. For instance, system bus 508 communicatively connects the processor(s) 512 with the ROM 510, the system memory 504, the output device interface 506 and the permanent storage device 502.

In some implementations, the various memory units, the processor(s) 512 retrieve instructions to execute (and data to process) in order to execute the steps of the subject technology. The processor(s) 512 can be a single processor or a multi-core processor in different implementations. Additionally, the processor(s) can comprise one or more graphics processing units (GPUs) and/or GPS devices and/or one or more decoders, depending on implementation.

The ROM 510 stores static data and instructions that are needed by the processor(s) 512 and other modules of the processor-based system 500. Similarly, the processor(s) 512 can comprise one or more memory locations such as a CPU cache or processor in memory (PIM), etc. The storage device 502, is a read-and-write memory device. In some aspects, this device can be a non-volatile memory unit that stores instructions and data even when the processor-based system 500 is without power. Some implementations of the subject disclosure can use a mass-storage device (such as solid state, magnetic or optical storage devices) e.g., a permanent storage device 502.

Other implementations can use one or more a removable storage devices (e.g., magnetic or solid state drives) such as permanent storage device 502. Although the system memory can be either volatile or non-volatile, in some examples the system memory 504 is a volatile read-and-write memory, such as a random access memory. System memory 504 can store some of the instructions and data that the processor needs at runtime.

In some implementations, the processes of the subject disclosure are stored in system memory 504 (e.g., in a geographical information system), permanent storage device 502, ROM 510 and/or one or more memory locations embedded with the processor(s) 512. From these various memory units, processor(s) 512 retrieve instructions to execute and data to process in order to execute the processes of some implementations of the instant disclosure.

The bus 508 also connects to the input device interface 514 and output device interface 506. The input device interface 514 enables a user to communicate information and select commands to the processor-based system 500. Input devices used with the input device interface 514 may include for example, alphanumeric keyboards and pointing devices (also called “cursor control devices”) and/or wireless devices such as wireless keyboards, wireless pointing devices, etc.

Finally, as shown in FIG. 5, bus 508 also communicatively couples the processor-based system 500 to a network (not shown) through a network interface 516. It should be understood that the network interface 516 can be either wired, optical or wireless and may comprise one or more antennas and transceivers. In this manner, the processor-based system 500 can be a part of a network of computers, such as a local area network (“LAN”), a wide area network (“WAN”), or a network of networks, such as the Internet (e.g., the network 408, as discussed above).

In practice, the methods of the subject invention can be carried out by the processor-based system 500. In some aspects, instructions for performing one or more of the method steps of the present disclosure will be stored on one or more memory devices such as the storage 502 and/or the system memory 504.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an location information requests) to a client device (e.g., for purposes of determining pedestrian location information). Data generated at the client device can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

It is understood that the specific order or hierarchy of steps disclosed herein is exemplify some implementations of the subject technology. However, depending on design preference, it is understood that the specific order or hierarchy of steps in the processes can be rearranged. For example, some of the steps may be performed simultaneously. As such, the accompanying method claims present elements of the various steps in a sample order, and are not meant to be limited to the specific order or hierarchy presented.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

What is claimed is:

1. A method for determining and labeling areas of interest, the method comprising:
receiving a plurality of data points from a plurality of users, each data point received at a particular time;
determining a user location for each of the plurality of data points;
generating a heat map from the plurality of data points, wherein the heat map represents a population density distribution over a geographic area divided into a plurality of cells;
identifying cells within the geographic area having a population density that exceeds a threshold;
identifying at least one cluster of cells within the geographic area from the identified cells;
generating a bounded polygon for the at least one cluster of cells; and
storing the at least one cluster of cells and its corresponding bounded polygon as an area of interest in a geographical information system.

2. The method of claim 1, further comprising determining the threshold from an average population density for the cells in the geographic area.

3. The method of claim 1, wherein generating a heat map from the plurality of received data points further comprises generating the heat map for a particular period of time based on the plurality of data points received during that period of time.

4. The method of claim 3, wherein the particular period of time comprises at least one of a morning, an afternoon, a daytime, a nighttime, a weekday, a weekend or a season.

5. The method of claim 1, wherein the plurality of data points include at least one of GPS data, Wi-Fi access point data, check-in data, or IP geo-location data.

6. The method of claim 1, further comprising:
identifying a first cluster of cells and a second cluster of cells within the geographic area from the identified cells; and
generating a first bounded polygon for the first cluster of cells and a second bounded polygon for the second cluster of cells, wherein the first bounded polygon and the second bounded polygon are generated in parallel.

7. The method of claim 6, further comprising:
merging the first bounded polygon and the second bounded polygon based on an amount of area overlap shared by the first bounded polygon and the second bounded polygon.

8. A system for determining and labeling areas of interest, the system comprising:
one or more processors; and
a machine-readable medium comprising instructions stored thereon, which when executed by the processors, cause the processors to perform operations comprising:
receiving a plurality of data points from a plurality of users, each data point received at a particular time;
determining a user location for each of the plurality of data points;
generating a heat map from the plurality of data points, wherein the heat map represents a population density distribution over a geographic area divided into a plurality of cells;
determining a threshold from an average population density for the cells in the geographic area;
identifying cells within the geographic area having a population density that exceeds the threshold;
identifying at least one cluster of cells within the geographic area from the identified cells;
generating a bounded polygon for the at least one cluster of cells; and
storing the at least one cluster of cells and its corresponding bounded polygon as an area of interest in a geographical information system.

9. The system of claim 8, wherein generating a heat map from the plurality of received data points further comprises generating the heat map for a particular period of time based on the plurality of data points received during that period of time.

10. The system of claim 9, wherein the particular period of time comprises at least one of a morning, an afternoon, a daytime, a nighttime, a weekday, a weekend or a season.

11. The system of claim 8, wherein the plurality of data points include at least one of GPS data, Wi-Fi access point data, check-in data, or IP geo-location data.

12. The system of claim 8, further comprising:
identifying a first cluster of cells and a second cluster of cells within the geographic area from among the identified cells having a population density that exceeds the threshold; and
generating a first bounded polygon for the first cluster of cells and a second bounded polygon for the second cluster of cells, wherein the first bounded polygon and the second bounded polygon are generated in parallel.

13. The system of claim 12, further comprising:
merging the first bounded polygon and the second bounded polygon based on an amount of area overlap shared by the first bounded polygon and the second bounded polygon.

14. A machine-readable medium comprising instructions stored therein, which when executed by a machine, causes the machine to perform operations comprising:
receiving a plurality of data points from a plurality of users, each data point received at a particular time;
determining a user location for each of the plurality of data points;
generating a heat map from the plurality of data points, wherein the heat map represents a population density distribution over a geographic area divided into a plurality of cells;
determining a threshold from an average population density for the cells in the geographic area;
identifying cells within the geographic area having a population density that exceeds the threshold;
identifying at least one cluster of cells within the geographic area from the identified cells;
generating a bounded polygon for the at least one cluster of cells; and
storing the at least one cluster of cells and its corresponding bounded polygon as an area of interest in a geographical information system.

15. The machine-readable medium of claim 14, wherein generating a heat map from the plurality of received data points further comprises generating the heat map for a particular period of time based on the plurality of data points received during that period of time.

16. The machine readable medium of claim 15, wherein the particular period of time comprises at least one of a morning, an afternoon, a daytime, a nighttime, a weekday, a weekend or a season.

17. The machine-readable medium of claim 14, wherein the plurality of data points include at least one of GPS data, Wi-Fi access point data, check-in data, or IP geo-location data.

18. The machine-readable medium of claim 14, further comprising:
identifying a first cluster of cells and a second cluster of cells within the geographic area from among the identified cells having a population density that exceeds the threshold; and
generating a first bounded polygon for the first cluster of cells and a second bounded polygon for the second cluster of cells, wherein the first bounded polygon and the second bounded polygon are generated in parallel.

19. The machine-readable medium of claim 14, further comprising:
merging the first bounded polygon and the second bounded polygon based on an amount of area overlap shared by the first bounded polygon and the second bounded polygon.

20. The machine-readable medium of claim 14, further comprising:
identifying one or more low density cells within the geographic area having a population density less than the threshold; and
discarding the one or more low density cells.
